(19) United States
(12) Patent Application Publication
(10) Pub. No.: US 2017/0371942 A1
(43) Pub. Date: Dec. 28, 2017

(54) MIGRATING OF USER INTERFACES USING AN ENHANCED UNIFIED METADATA REPOSITORY

(71) Applicant: SAP SE, Walldorf (DE)

(72) Inventors: Dirk Baumgaertel, Weisloch (DE); Michael Belenki, Karlsruhe (DE)

(21) Appl. No.: 15/189,535

(22) Filed: Jun. 22, 2016

(51) Int. Cl. G06F 17/30

(52) U.S. Cl. CPC G06F 17/30575; G06F 17/30569

(57) ABSTRACT

A computerized method, system and computer-medium for migrating reports to an enhanced user experience are described. In one example, an existing report for migration to an enhanced user experience application is identified, where the existing report is associated with existing metadata for selection screen presentation and backend coding. A metadata object associated with the identified report is created, and at least some of the existing metadata associated with the identified existing report is replicated into the created metadata object based on the relationship between the existing report and the enhanced report. At least one enhancement to the created metadata object is received, where the at least one enhancement includes at least one additional metadata attribute to be represented in an updated selection screen presentation associated with the enhanced user experience application. The created metadata object is then persisted for later execution.

### TECHNICAL FIELD

The present disclosure relates to computer systems and computer-implemented methods for migrating existing reports to an enhanced user experience.

Software developers consistently update and modify systems, applications, and user interface-based software and presentations in an effort to provide customers with the best user experience and technology available. Due to these updates, developers consistently must recreate previous solutions to be used in the new software. Further, when new user experience layers are provided, additional recreations of existing software, including reports, must be recreated to satisfy the requirements of the new systems.

Recent software for enhanced user experiences can be used to provide simpler and personalized user experiences with existing software, improve productivity by simplifying legacy applications and tasks, reduce training and support costs with easier-to-use screens, and boost user adoption with appealing designs tailored to key tasks and activities.

Further, online and cloud applications may be accessed and executed using REST (representation state transfer)-based services. Such services allow lightweight, maintainable, and scalable services, where the service can be accessed using an HTTP protocol, as well as other suitable protocols.

### SUMMARY

The disclosure generally describes computer-implemented methods, software, and systems for migrating reports to an enhanced user experience are described. An example method includes migrating an existing report to an enhanced user experience application is identified, where the existing report is associated with existing metadata for selection screen presentation and backend coding. A metadata object associated with the identified report is created, and at least some of the existing metadata associated with the identified existing report is replicated into the created metadata object based on the relationship between the existing report and the enhanced report. At least one enhancement to the created metadata object is received, where the at least one enhancement includes at least one additional metadata attribute to be represented in an updated selection screen presentation associated with the enhanced user experience application. The created metadata object is then persisted for later execution.

In some instances, a request to execute the identified report in the enhanced user experience application is received. The created metadata object associated with the particular report is identified, and an updated selection screen based at least partly on the identified metadata object is presented, the updated selection screen presentation including the at least one enhancement of the created metadata object applied to the existing metadata associated with the existing report. The identified report is executed based on input received via the updated selection screen, wherein executing the identified report comprises using the backend coding for execution. In some instances, the backend coding for execution comprises the backend coding associated with the existing report.

In some instances, the metadata object is associated with the identified report based on a header corresponding to the name of the identified report. The operations may be performed by a generic service operable to migrate any existing report to the enhanced user experience application. In some instances, replicating at least some of the existing metadata associated with the identified existing report into the created metadata object comprises identifying a set of parameters associated with the existing report and incorporating at least a portion of the identified set of parameters into the created metadata object. In some instances, the at least one additional metadata attribute includes layout information associated with the updated selection screen presentation, a determination of one or more mandatory fields within the updated selection screen presentation, a grouping of fields within the updated selection screen presentation, and dependency information between at least two fields in the updated selection screen presentation. In other instances, at least one additional metadata attribute includes a set of coding value help information, the coding value help information identifying a range or type of value information associated with at least one field included in the updated selection screen presentation.

The existing report can be associated with a legacy system in some instances. Further, the created metadata object is persisted in the same location as the existing report.

While generally described as computer implemented software embodied on tangible media that processes and transforms the respective data, some or all of the aspects may be computer implemented methods or further included in respective systems or other devices for performing this described functionality. Specifically, particular implementations of described methods and systems can include corresponding computer systems, apparatuses, or computer programs (or a combination of computer systems, apparatuses, and computer program) recorded on one or more computer storage devices, each configured to perform the actions of the methods. A system of one or more computers can be configured to perform particular operations or actions by virtue of having software, firmware, hardware, or a combination of software, firmware, or hardware installed on the system that, in operation, causes the system to perform the actions. One or more computer programs can be configured to perform particular operations or actions by virtue of including instructions that, when executed by data processing apparatus, cause the apparatus to perform the actions. The details of these and other aspects and embodiments of the present disclosure are set forth in the accompanying drawings and the description below. Other features, objects, and advantages of the disclosure will be apparent from the description and drawings, and from the claims.

### DESCRIPTION OF DRAWINGS

FIG. 1 is a block diagram illustrating an example system for enabling migration of existing reports into an enhanced user experience environment.

FIG. 2 is a simplified diagram presenting connections between elements of example FIG. 1.

FIG. 3 is an illustration of example operations for generating an enhanced metadata layer for presenting and executing existing report functionality in an enhanced user experience environment.

FIG. 4 is an illustration of example operations for executing a report in the enhanced user experience environment based on the additional metadata layer and existing report functionality.

FIG. 5 is an example illustration of a screen selection element of an existing report.

FIG. 6 is an example illustration of a set of parameters associated with a particular report and its existing metadata.

FIG. 7 is an example illustration of an enhanced screen selection element of a migrated report for use in the enhanced user experience environment.

FIG. 8 is an illustration of an example swim lane diagram associated with operations for executing a report in the enhanced user experience environment.

### DETAILED DESCRIPTION

This present disclosure generally describes computer-implemented methods, software, and systems for migrating existing reports into an enhanced user experience (UX) application. Specifically, reports created and existing in one or more existing systems may be readily available. When businesses and developers provide an advanced (and enhanced) UX, however, these existing reports must be recreated in order to take advantage of the experience provided by the advanced systems. In the present solution, these existing reports are migrated to the enhanced UX via migration of the selection screens associated with those reports, where the reports comprise two distinct parts: the selection screens identifying inputs upon which the report is to be based, and backend coding in the system in which the existing report is located that is used to execute the reports once inputs are provided. The reports are executable programs that read data from an underlying database or data store and generates output based on the filter criteria as selected by the end user via the selection screen. The output may include a result presentation to a user, the generation of a log, or execution or actions performed by the backend system or another related system in response to the output.

In one example, reports may initially exist in a client/server model-based system that provides the ability to store, retrieve, analyze, and process business processes and related data. However, newer systems may provide an in-memory computing platform designed to run on any database platform, where said platform may be associated with an enhanced UX application providing modern design principles, including device-agnostic user interfaces (UIs) that allow easy porting of applications to any suitable client, including mobile devices. The existing reports may not be formatted for or available in the enhanced UX application. In many instances, the existing reports may be associated with background jobs for the existing or prior system, such that a mechanism is needed to migrate and subsequently run the reports in the new system. The present solution provides a generic solution for migration of existing reports to be associated with the new system and its enhanced UX application with minimal adoption effort, thereby avoiding costly rework of the already available existing report. While the primary benefit of the migration may include moving from previous systems to new systems, the generic solution allows for migration of both legacy reports and current reports. In other words, not only may the legacy reports be migrated with additional enhancement, but existing reports in the current system may also be migrated and enhanced with the current solution, allowing users and developers a simple and lightweight report enhancement solution.

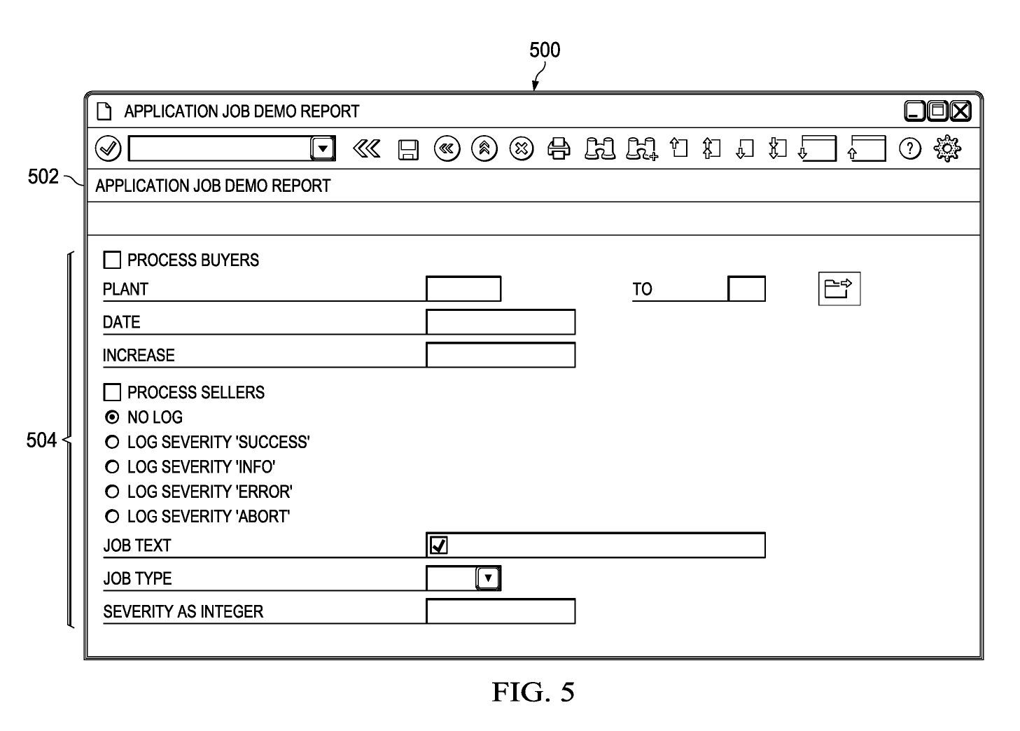

FIG. 5 illustrates an example illustration of a screen selection element 500 of an existing report to be migrated. The existing report includes two pieces, the UI coding identifying the particular parameters and fields to be presented when initiating the report, as well as the backend coding performed by the system with which the existing report is associated. The screen selection element 500 includes a plurality of fields related to an application job demo report 502, including selection fields 504 of “Process Buyers” and “Process Sellers,” among other fields and related sub-fields. These selectable and/or input-based fields represent parameters associated with the report, and can be used to determine the operations performed when the report is executed.

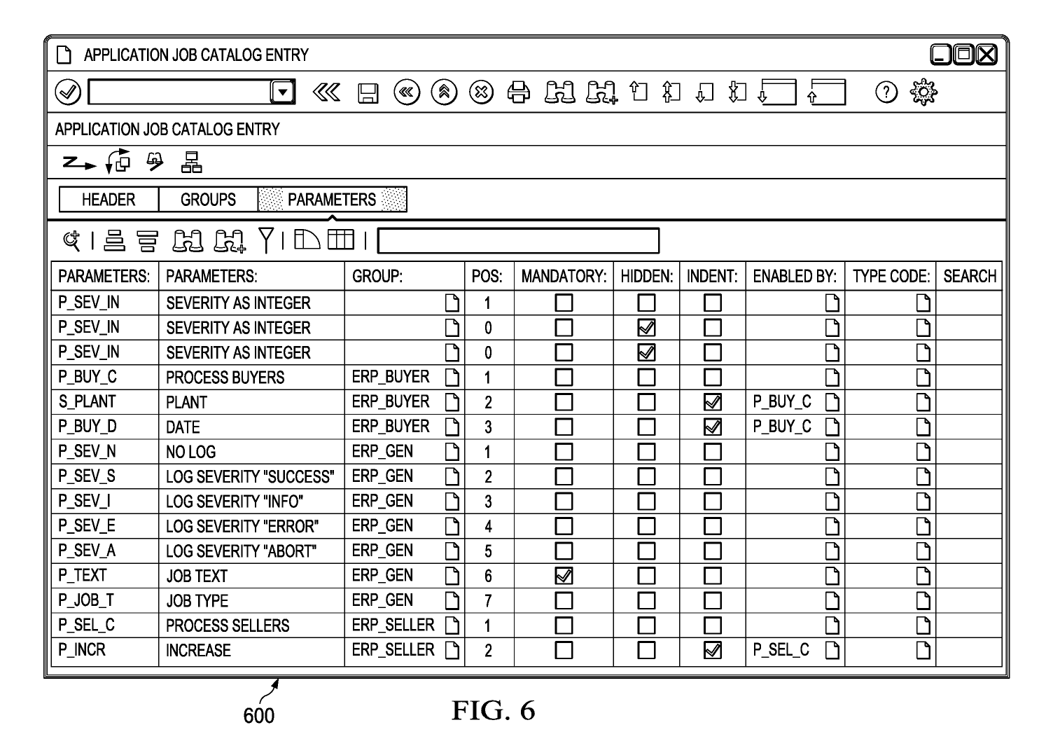

FIG. 6 illustrates a set of metadata associated with the existing report that is used during the migration process. The set of metadata corresponds to a newly created metadata object 600, the application job catalog entry metadata object 600. As illustrated, the application job catalog entry metadata object 600 replicates at least a portion of the information included in metadata used to define the selection screen of the application job demo report 500. Specifically, the parameters and at least a portion of their metadata defining the presentation of the selection screen is included in the new object 600. However, the application job catalog entry metadata object 600 can be modified to create an enhanced selection screen for use in the enhanced UX application. In doing so, the incorporated metadata can be modified as desired, while retaining the backend coding for use in executing the underlying report. For example, particular parameters can be associated within a group, thereby defining how the parameters will be presented on the UI. Additionally, one or more of the parameters may be made mandatory such that an entry is required, while one or more of the other parameters are hidden. Further, specific positions of the parameters in the UI can be updated or changed, as well as their indention or other presentation specifics, among others. Once the specifics of the updated metadata are defined, the application job catalog entry metadata object 600 can be stored apart from the original report. The job catalog entry metadata object 600, however, can be accessed upon and used in the execution of the report in the enhanced UX application.

The solution for generating the enhanced report includes two pieces: the UI coding and the backend coding associated with the existing report. The UI and backend can communicate with each other, e.g., through an OData service. In one solution, the OData service may be SAP's Gateway, a technology that provides a simple way to connect devices, environments, and platforms to SAP software. The gateway, for example, can manage communications between distinct systems via OData protocols. The gateway may include additional services and operations, including validation of fields for entries in particular selection screens prior to providing the input to the backend system.

The backend coding executes based on the inputs from the selection screens, and is capable of accessing the existing metadata managing the execution of the reports. The information including this metadata is exposed via the generic OData service to the UI, such that a single OData service can be generically used for all reports without requiring each report to use its own OData service.

The gateway and/or the particular gateway service dedicated to the migration of the reports performs operations to merge the metadata of the existing report with the enhanced metadata object based on the association of the metadata object to the existing report. In some instances, the gateway can further ensure that checks on the data are performed, as well as manipulation of the particular parameter values.

FIG. 7 illustrates the migrated selection screen of the report after the merging of the existing metadata and the created metadata object is performed. Specifically, the migrated selection screen is illustrated in the enhanced UX application. The enhanced UX application renders the existing report from above based on the merged metadata information—that is, as illustrated the parameters are grouped in different sections and include indentions as specified in the enhanced metadata object 600 of FIG. 6. For example, the “Process Buyers” selection field 610 is now grouped with the “Plant” text box 615 and the “Date” text box 620 in the Buyer group 605, with the Plant 615 and Date 620 boxes dependent upon and indented from the Process Buyers selection field 610. The dependency information means that in order for Plant 615 and Date 620 to be editable, the Process Buyers field 610 must be selected/activated. Similarly, the “Process Sellers” selection field 630 and the “Increase” text box 635 are grouped together in the Seller group 625, with the “Increase” text box 635 dependent on and indented from the “Process Sellers” field 630. The additional parameters 645 are associated with the General group 640 as defined in the metadata object 600.

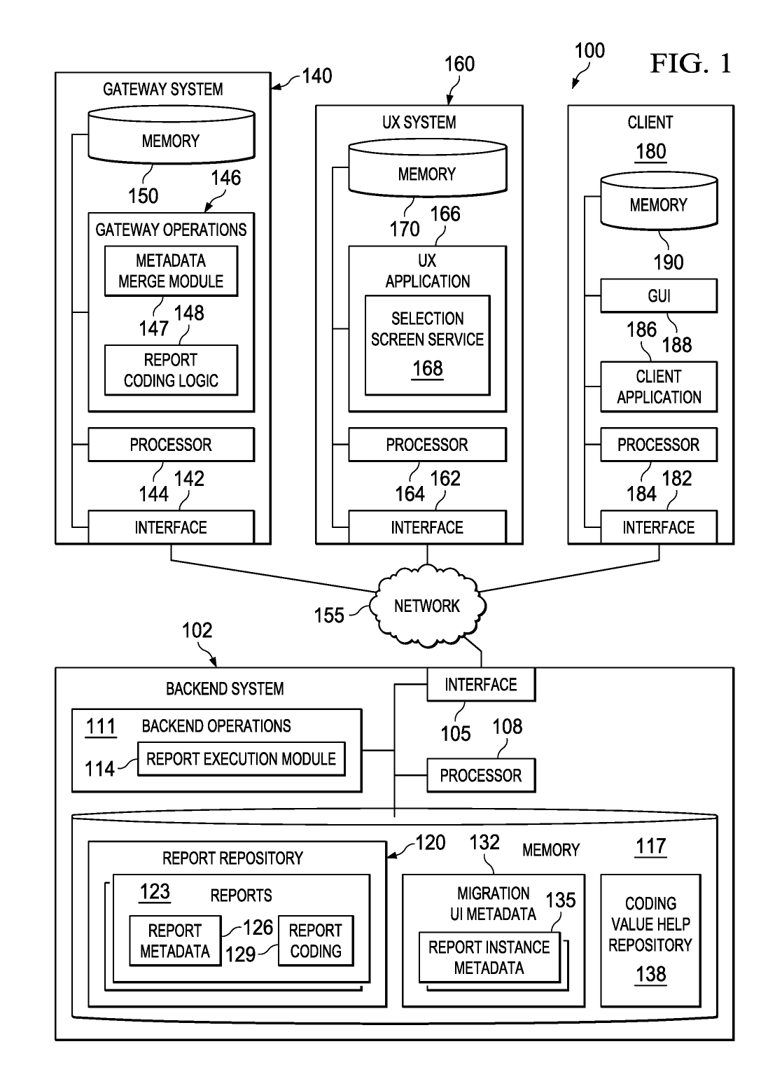

Turning to the illustrated embodiment, FIG. 1 is a block diagram illustrating an example system 100 for enabling migration of existing reports into an enhanced user experience environment as illustrated above. As illustrated in FIG. 1, system 100 is a client-server or cloud-based system capable of migrating one or more existing reports defined in a backend system to be used or presented in an enhanced UX application, such as the UX system 160 illustrated in FIG. 1. The migration process can enhance reports 123 located at backend system 102 using a set of migration UI metadata 132, where the existing metadata 126 associated with the existing report 123 is merged with the migration UI metadata 132 (as defined by a user or administrator) by the gateway system 140 and executed within the UX system 160 for presentation to one or more clients 180. In some instances, the backend system 102 may be a legacy system in which the existing reports 123 have been previously generated and executed. In other instances, the backend system 102 may be a current system, where the migration operations are used to customize or otherwise modify or enhance particular reports.

As illustrated, system 100 includes or is communicably coupled with the backend system 102, gateway system 140, UX system 160, and client 180, where these systems are connected, at least in part, by network 155. Although components are shown individually, in some implementations, functionality of two or more components, systems, or servers may be provided by a single component, system, or server. Similarly, in some implementations, the functionality of one illustrated component, system, or server may be provided by multiple components, systems, servers, or combinations thereof. Conversely, multiple components may be combined into a single component, system, or server, where appropriate.

As used in the present disclosure, the term “computer” is intended to encompass any suitable processing device. For example, client 180, backend system 102, gateway system 140, and UX system 160, among other illustrated and non-illustrated components, may be any computer or processing device such as, for example, a blade server, general-purpose personal computer (PC), Mac®, workstation, UNIX-based workstation, smartphone, tablet, or any other suitable device. Moreover, although FIG. 1 illustrates the various elements individually (e.g., the backend system 102), any such systems can be implemented using two or more systems, as well as computers other than servers, including a server pool. Alternatively, the functionality provided by some portions of the system 100 may be included (in whole or in part) at one or more other components within the system 100. In some instances, the network 155 may provide cloud-based solutions for any of the elements, as well as other suitable combinations and permutations. The present disclosure contemplates computers other than general purpose computers, as well as computers without conventional operating systems.

In general, the backend system 102 is a system associated with one or more reports 123 in a report repository 120, where each report 123 is associated with a set of report metadata 126 and report coding 129. The report metadata 126 for each report identifies particular parameters or attributes associated with the report, including items for which user input is to be requested. The report coding 129 includes executable code for use in executing the corresponding report 123 upon receipt of the associated inputs to the report 123 (as provided by a user or automatically by the system).

As illustrated, the backend system 102 includes an interface 105, a processor 108, a set of backend operations 111, and memory 117. The interface 105 is used by the backend system 102 for communicating with other systems in a distributed environment—including within the environment 100—connected to the network 155, e.g., gateway system 140, UX system 160, client 180, as well as other systems communicably coupled to the network 155. Generally, the interface 105 comprises logic encoded in software and/or hardware in a suitable combination and operable to communicate with the network 155. More specifically, the interface 105 may comprise software supporting one or more communication protocols associated with communications such that the network 155 or interface's hardware is operable to communicate physical signals within and outside of the illustrated environment 100.

Network 155 facilitates wireless or wireline communications between the components of the environment 100 (e.g., between the backend system 102 and the gateway system 140, between the UX system 160 and the gateway system 140, between client 180 and the UX system parser system 160, as well as with any other local or remote computer, such as additional clients, servers, or other devices communicably coupled to network 155, including those not illustrated in FIG. 1). In the illustrated environment, the network 155 is depicted as a single network, but may be comprised of more than one network without departing from the scope of this disclosure, so long as at least a portion of the network 155 may facilitate communications between senders and recipients. In some instances, one or more of the illustrated components may be included within network 155 as one or more cloud-based services or operations. The network 155 may be all or a portion of an enterprise or secured network, while in another instance, at least a portion of the network 155 may represent a connection to the Internet. In some instances, a portion of the network 155 may be a virtual private network (VPN). Further, all or a portion of the network 155 can comprise either a wireline or wireless link. Example wireless links may include 802.11a/b/g/n/ac, 802.20, WiMax, LTE, and/or any other appropriate wireless link. In other words, the network 155 encompasses any internal or external network, networks, sub-network, or combination thereof operable to facilitate communications between various computing components inside and outside the illustrated environment 100. The network 155 may communicate, for example, Internet Protocol (IP) packets, Frame Relay frames, Asynchronous Transfer Mode (ATM) cells, voice, video, data, and other suitable information between network addresses. The network 155 may also include one or more local area networks (LANs), radio access networks (RANs), metropolitan area networks (MANs), wide area networks (WANs), all or a portion of the Internet, and/or any other communication system or systems at one or more locations.

The backend system 102 further includes processor 108. Although illustrated as a single processor 108 in FIG. 1, two or more processors 108 may be used according to particular needs, desires, or particular implementations of the environment 100. Each processor 108 may be a central processing unit (CPU), an application specific integrated circuit (ASIC), a field-programmable gate array (FPGA), or another suitable component. Generally, the processor 108 executes instructions and manipulates data to perform the operations of the backend system 102. Specifically, the processor 108 executes the algorithms and operations described in the illustrated figures, including the operations performing the functionality associated with the backend system 102 generally, as well as the various software modules and operations (e.g., the backend operations 111 and report execution module 114), including the functionality for sending communications to and receiving transmissions from the various systems involved in the migration and execution of reports.

As noted, the backend system 102 includes and performs a set of backend operations 111 associated with the normal functionality of the backend system 102, including a report execution module 114 for executing the functionality associated with each of the reports 123. Specifically, the report execution module 114 can access the report coding 129 associated with particular reports, and use inputs associated with the report 123 to execute the functionality and coding of the report 123. The backend operations 111 and report execution module 114 may be applications, set of applications, software, software modules, or combination of software and hardware used to perform the operations of the backend system 102.

Regardless of the particular implementation, “software” includes computer-readable instructions, firmware, wired and/or programmed hardware, or any combination thereof on a tangible medium (transitory or non-transitory, as appropriate) operable when executed to perform at least the processes and operations described herein. In fact, each software component may be fully or partially written or described in any appropriate computer language including C, C++, JavaScript, Java™, Visual Basic, assembler, Perl®, any suitable version of 4GL, as well as others.

The backend system 102 also includes memory 117, or multiple memories 117. The memory 117 may include any memory or database module(s) and may take the form of volatile or non-volatile memory including, without limitation, magnetic media, optical media, random access memory (RAM), read-only memory (ROM), removable media, or any other suitable local or remote memory component. In some instances, at least a portion of the memory 117 may include an in-memory database. The memory 117 may store various objects or data, including financial data, user information, administrative settings, password information, caches, applications, backup data, repositories storing business and/or dynamic information, and any other appropriate information including any parameters, variables, algorithms, instructions, rules, constraints, or references thereto associated with the purposes of the backend system 102. Additionally, the memory 117 may store any other appropriate data, such as VPN applications, firmware logs and policies, firewall policies, a security or access log, print or other reporting files, as well as others. As illustrated, memory 117 can store the report repository 120 (described above), the migration UI metadata 132, and a coding value help repository 138, as well as any other information relevant to the backend system 102.

The report repository 120 may be a single repository, database, or storage location associated with the reports 123 in some instances. In others, the report repository 120 may be a plurality of repositories, databases, or storage locations at which the reports 123 are located. In some instances, some or all of the report repository 120 and the reports 123 inside may be located apart from the backend system 102. Generally, the reports 123 in the report repository 120 are not modified during the migration process, as the additional migration UI metadata 132 provides for enhancements on a layer above the reports 123, with the gateway system performing the merging of the metadata at execution time to allow for presentation of the corresponding enhanced selection screens. In some instances, the report repository 120 and the migration UI metadata 132 can be combined into a unified metadata repository where all metadata, both existing and enhanced, associated with particular reports is stored for quick and efficient accessing and processing by the enhanced UX application and the backend system 102.

The migration UI metadata 132 can include one or more created metadata objects used to extend and migrate particular reports 123 to an enhanced UX application, such as the UX system 160. In particular, the migration UI metadata 132 can be used to modify, update, and alter the presentation of selection screens associated with the report 123, and therefore alter the presentation of the report screens as presented to the user, e.g., at client 180. The migration UI metadata 132 can include one or more report instance metadata objects 135, where the report instance metadata objects 135 are merged with the report metadata 126 at runtime to migrate the reports to the enhanced UX application. In doing so, the report instance metadata objects 135 can define modified presentation parameters and attributes associated with the migrated report, where such modifications can result in an enhanced presentation of the selection screens as illustrated in the examples of FIGS. 5 through 7. Importantly, the migration UI metadata 132 does not affect the underlying execution of the report 123—specifically, the report coding 129. Instead, the migration UI metadata 132 can define changes to the presentation of the selection screen and modify the information collected for passing to the report coding 129 for execution by the report execution module 114. The report instance metadata object 135 may be associated with or linked to a particular report 123 in various ways. In generating the report instance metadata object 135, at least a portion of the underlying report metadata 126 for the migrated existing report 123 may be replicated and/or imported into the new object. This information can include header information, specific linking information (e.g., based on unique report identifiers), and other association information. At execution, the relationship between the report instance metadata object 135 and the existing report 123 can be identified and used to merge the existing report metadata 126 with the enhanced metadata object 135.

The coding value help repository 138 includes various coding value assistance as defined by users. Specifically, during the process of defining one or more enhancements to the report 123 as described herein, one or more coding value help actions may be defined. The coding value help actions include input assistance when an end user activates, for instance, help functionality associated with the report 123 and its selection screen (e.g., by pressing the “F4” key). In some instances, one or more dedicated searches may be provided within the migrated selection screen using the coding value help repository 138 and its metadata, such that users may enter text into a text field for searching dedicated or particular topics or data.

The illustrated environment 100 further includes gateway system 140. Gateway system 140 provides a method of communication between the UX system 160 and the backend system 102 through a provided OData service. As illustrated, the gateway system 140 includes interface 142, process 144, gateway operations 146, and memory 150. The interface 142 and processor 144 may be similar to or different than interface 105 and processor 108. In general, processor 108 executes instructions and manipulates data to perform the operations of the gateway system 140. Specifically, the processor 144 executes the algorithms and operations associated with the gateway system 140, including the operations associated with merging the existing report metadata 126 with the migration UI metadata 132 (and particular report instance metadata 135) corresponding to a particular report instance being executed at the UX system 160, as well as the normal gateway operations 146 associated with the gateway system 140. Further, memory 150 may be similar to or different than memory 117. While illustrated generally, memory 150 may store or maintain information related to the gateway system 140.

As illustrated, in addition to the standard gateway operations 146 used to connect different systems, the gateway operations 146 include a metadata merge module 147 and a report coding logic module 148. The metadata merge module 147 performs operations to merge, in response to requests to execute a migrated report 123, the existing report metadata 126 and the corresponding report instance metadata 135 included in the migration UI metadata 132, thereby enabling the execution of the migrated report 123 in the enhanced UX application. The report coding logic module 148 of the gateway operations 146 performs actions to process the input provided by users or the system within particular selection screens to perform the additional checks and/or manipulation of parameter values to ensure proper execution of the report 123. One example may be realized in a materials requirement planning application execution. A particular exit performed by the report coding logic module 148 may include checking if a combination of a product and associated plan are valid before submitting the inputs to the backend. For example, manipulation of a particular parameter may be such that the system determines a default cost center of an employee where no cost center is provided as input. Alternatively, if a parameter is incorrectly entered, the report coding logic module 148 may identify an intended parameter matching the other input, and can automatically update the input prior to providing to the backend system. Other similar and different checks and manipulations may be available through the logic and capabilities of module 148.

UX system 160 represents a system providing an enhanced UX application 166. One example system may include an implementation of an SAP FIORI UX system. In general, the UX system 160 is able to provide a personalized and role-based user experience for enterprise-wide engagement across lines of business, across various applications, and across any number of deployment options. The UX system 160 provides optimal usability on multiple devices for quality presentations on various devices and ecosystems to increase the ease of use for users. Specifically, the UX application 166 applies modern design principles to new and existing applications, including for presentations of reports and other content. In the present illustration, the UX system 160 acts as a presentation layer to the execution of the various report 123, with the gateway system 140 performing the merge operations to collect and integrate the metadata 126, 135 associated with a particular report 123. The UX application 166, interpreting and using the combined metadata, presents a selection screen associated with the requested report. The selection screen allows user inputs of one or more parameters. Upon submission, the gateway system 140 connects with the original report coding 129 and the report execution module 114 to execute the report 123.

As illustrated, the selection screen service 168 of the UX system 160 allows users to migrate reports 123 to the enhanced system. Specifically, the selection screen service 168 allows users to create the enhanced metadata by identifying the report for migration, creating a metadata object associated with the identified report (e.g., based on a shared name, header, unique identifier, etc.), and replicating at least some of the existing metadata associated with the existing report into the created metadata object. The selection screen service 168 can then receive at least one metadata-based enhancement to the created metadata object, the enhancement representing at least one modified or new metadata attribute. The created metadata object is then persisted for later execution as described herein. In some instances, the created metadata object (e.g., the report instance metadata 132) is stored at or in the same location of the report repository 120 storing the associated report 123. In other instances, the object may be stored apart and/or remotely from the report repository 120. In some instances, the created metadata object may be enhanced with one or more coding value helps as described herein. Those helps can be stored with or apart from the migration UI metadata 132 in the coding value help repository 138.

The UX system 160 includes interface 162, processor 164, and memory 170. The interface 162 and processor 144 may be similar to or different than interfaces 105, 142 and processors 108, 144. In general, processor 164 executes instructions and manipulates data to perform the operations of the UX system 160. Specifically, the processor 164 executes the algorithms and operations associated with the UX system 160, including the operations associated with presenting and migrating reports 123 and their selection screens to a user, such as a user of client 180. Memory 170 may be similar to or different than memory 117, 150. While illustrated generally, memory 170 may store or maintain information related to the UX system 160.

In some instances, the UX system 160 may be a standalone system. Alternatively, the UX system 160 may be included in or part of another system, such as client application 186 of the client 180, as well as a cloud-based system or application.

Environment 100 includes one or more clients 180. Particular clients 180 may connect to any of the illustrated systems, and may include end users, developers, and administrators. For purposes of the actions described herein, client 180 may connect to the UX system 160 in migrating and executing particular reports 123. Each client 180 may be specifically associated with a particular user or multiple users. In other instances, clients 180 may be generally available computing systems accessible by a plurality of users. As illustrated, users may perform migration operations via client application 186, which may include or be associated with a web browser, a remotely executed application associated with the UX system 160, or any other suitable application or component. The client application 186 may be associated with an application window or presentation (e.g., GUI 188) used to present information associated with that application 186 to the user regarding particular reports 123 and their corresponding selection screens.

The illustrated client 180 is intended to encompass any computing device such as a desktop computer, laptop/notebook computer, mobile device, smartphone, personal data assistant (PDA), tablet computing device, one or more processors within these devices, or any other suitable processing device. In general, the client 180 and its components may be adapted to execute any operating system, including Linux, UNIX, Windows, Mac OS®, Java™, Android™, or iOS. According to one implementation, the illustrated systems may also include or be communicably coupled with a communication server, an e-mail server, a web server, a caching server, a streaming data server, and/or other suitable server or computer. In some instances, the client 180 may comprise a computer that includes an input device, such as a keypad, touch screen, or other device(s) that can interact with the client application 186, and an output device that conveys information associated with the operation of the applications and their application windows to the user of the client 180. Such information may include digital data, visual information, or a GUI 188, as shown with respect to the client 180. Specifically, the client 180 may be any computing device operable to connect to or communicate with the UX system 160, the backend system 102, the gateway system 140, other clients 180, and/or other components via network 155, as well as with the network 155 itself, using a wireline or wireless connection. In general, client 180 comprises an electronic computer device operable to receive, transmit, process, and store any appropriate data associated with the environment 100 of FIG. 1.

As illustrated, client 180 includes an interface 182, a processor 184, client application 186, a graphical user interface (GUI) 188, and memory 190. The interface 182 and processor 184 may be similar to or different than the interfaces and processors of FIG. 1. In general, processor 184 executes instructions and manipulates data to perform the operations of the client 180. Specifically, the processor 184 executes the algorithms and operations described in the illustrated figures and associated with the client 180, including the operations performing the functionality associated with the client application 186. In some instances, the client 180 may be integrated with the UX system 160, either by inclusion of the UX application 166 with the client 180, or by a remote connection for executing the UX application 166. The processor 184 can manage such executions. Further, memory 190 may be similar to or different than the other memories described in FIG. 1. While illustrated generally, memory 190 may store or maintain information related to the client 180, as well as other suitable data.

GUI 188 of the client 180 interfaces with at least a portion of the environment 100 for any suitable purpose, including generating a visual representation of the client application 186 and/or the UX application 166. In particular, the GUI 188 may be used to view a selection screen presentation associated a particular report 123, as well as the selection screen service 168 used to migrate one or more reports 123 for execution in conjunction with the UX system 160. GUI 188 may also be used to view and interact with various Web pages and applications located local or external to the client 180. Generally, the GUI 188 provides the user with an efficient and user-friendly presentation of data provided by or communicated within the system. The GUI 188 may comprise a plurality of customizable frames or views having interactive fields, pull-down lists, and buttons operated by the user. For example, the GUI 188 may provide interactive elements that allow a user to view or interact with information related to the operations of the process associated with the selection screen service 168. In general, the GUI 188 is often configurable, supports a combination of tables and graphs (bar, line, pie, status dials, etc.), and is able to build real-time portals, application windows, and presentations. Therefore, the GUI 188 contemplates any suitable graphical user interface, such as a combination of a generic web browser, a web-enable application, intelligent engine, and command line interface (CLI) that processes information in the platform and efficiently presents the results to the user visually.

While portions of the elements illustrated in FIG. 1 are shown as individual modules that implement the various features and functionality through various objects, methods, or other processes, the software may instead include a number of sub-modules, third-party services, components, libraries, and such, as appropriate. Conversely, the features and functionality of various components can be combined into single components as appropriate.

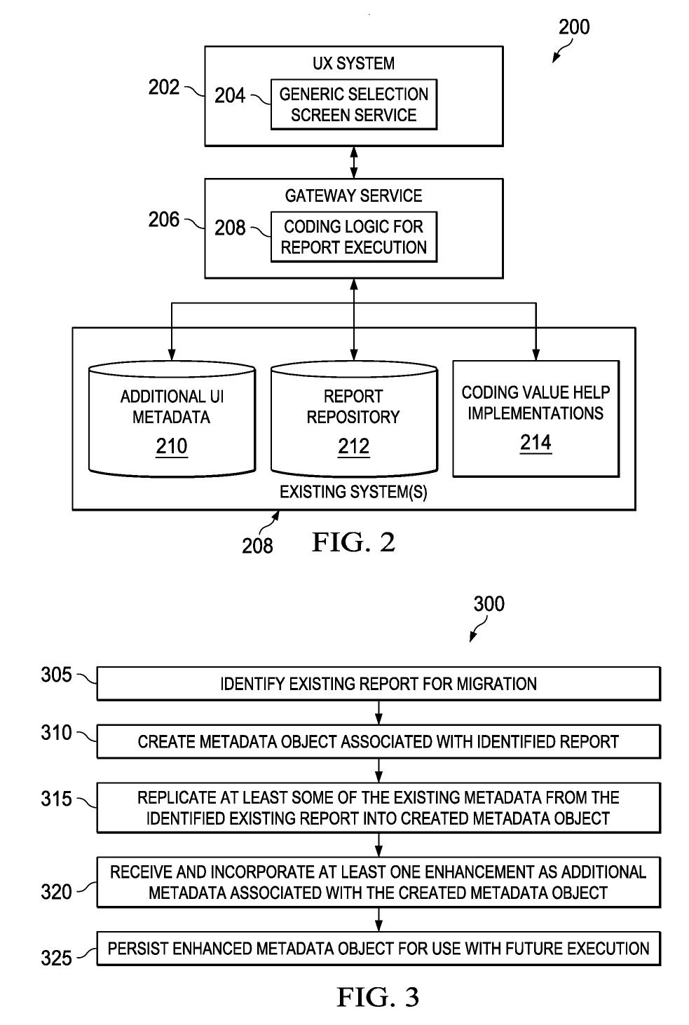

FIG. 2 is a simplified diagram presenting connections between elements of example FIG. 1. FIG. 2 is similar to the components of FIG. 1, but is not intended to be an identical representation. As illustrated, environment 200 includes a UX system 202, a gateway service 206, and one or more existing systems 208.

As illustrated, the UX system 202 and the existing systems 208 can communicate via the gateway service 206. Existing reports can be stored in the report repository 212 (including both existing report metadata and existing report coding for execution). In some instances, those reports may be in a legacy format, where the migration process moves the legacy presentation into the enhanced UX presentation. In other instances, the reports may be available in a current format, where the migration modifies the presentation of the report for a customized experience. This is especially helpful where the existing report is pre-configured by a developer, where customers and end users wish to create customized reports and selection screens for their users and/or themselves.

Via the UX system 202 and its generic selection screen service 204, a particular existing report for migration can be selected. Upon selection, a metadata object associated with the identified report is created. Here, that created metadata object is stored with the additional UI metadata repository 210. While illustrated in the existing system 208, the additional UI metadata repository 210, or a portion thereof, may be located elsewhere in any suitable location. In response to the creation, at least some of the existing metadata associated with the identified existing report is replicated into the created metadata object. Such replication can assist in associating the additional metadata object with the existing report, as well as the inclusion of a listing of parameters associated with the existing metadata. Once the data is replicated, at least one enhancement to the created metadata object is received, where the enhancement(s) include and/or identify at least one attribute to be represented in an updated selection screen presentation for use in executing the existing report via the UX system 202. Such enhancements may include grouping one or more of the parameters in the presentation, changing indention of the parameters as they are presented, hiding one or more previously presented parameters in the enhanced selection screen, adding dependency relationships between two or more of the parameters, change parameter presentation (e.g., names or labels), as well as others. Once complete, the created metadata object is persisted for future execution. In some instances, the generic selection screen service 204 can allow users to add one or more coding value help options and implementations. These may be stored in a coding value help implementation repository 214, or they may be stored with the additional UI metadata 210.

To execute a migrated report, the user can submit a request via the UX system 202 to execute the report. The request is sent via the gateway service 206, which manages the merging of metadata for execution of the migrated report. The gateway service 206 can identify whether additional UI metadata 210 associated with the requested report exists, in particular the created metadata object. The gateway service 206 can also access the existing metadata from the report repository 212 to generate a combined set of metadata, which is passed to the UX system 202 and is there used to interpret and present the updated selection screen based on the enhancements form the metadata object. As inputs are received through the UX system 202, they are passed via the gateway system 206 to the report repository 212 and the corresponding backend system (not illustrated) for execution. As described above, the existing coding can interpret the received input and execute without requiring any coding changes to the execution portion of the report. In some instances, the gateway service 206 may include coding logic 208 to assist in the report execution, where the coding logic can perform one or more validations of the received input before passing the input to the report code at the backend system. Other checks of the input data may be performed by the gateway service 206 and/or any other suitable component.

FIG. 3 is an illustration of example operations for generating an enhanced metadata layer for presenting and executing existing report functionality in an enhanced user experience environment. For clarity of presentation, the description that follows generally describes method 300 in the context of the system 100 illustrated in FIG. 1. However, it will be understood that method 300 may be performed, for example, by any other suitable system, environment, software, and hardware, or a combination of systems, environments, software, and hardware as appropriate.

At 305, an existing report is identified for migration. In some instances, users may specify a particular existing report for migration via a single generic service. The single generic service may be available via an enhanced UX application or system, such as SAP's FIORI UX application and environment. Each existing report may be associated with two parts—an existing set of metadata associated with a selection screen presented to users when attempting to execute the report and an existing set of report coding for execution of the report. The existing set of metadata can identify one or more parameters or attributes associated with the report, such as selectable fields used to filter or shape the report's execution and output.

In response to identifying the existing report, a new metadata object associated with the identified report is created at 310. The new metadata object can be created in the UX system, in the existing backend system in which the existing report resides, or in any suitable location. At 315, at least some of the existing metadata associated with the identified existing is replicated into the created metadata object. The replicated data may include a header or unique identifier, as well as a listing of one or more parameters associated with the report.

At 320, at least one enhancement is received and incorporated into the created metadata object as a modification to the selection screen associated with the identified report. The at least one enhancement can include grouping one or more of the parameters associated with the report in the selection screen presentation, changing indention of the parameters, hiding one or more previously presented parameters in the enhanced selection screen, adding dependency relationships between two or more of the parameters, changing parameter presentation (e.g., names or labels), as well as others. Additionally, enhancements may include additional help exits for users to assist in completion of the selection screen input. For example, actions to be taken when a user activates a field or activates a “help” button, such as the “F4” button, may be added as an enhancement. This may include providing a data type to be input, information on a range of values to be input, or other information and/or functionality. Once the addition of the information is complete, at 325 the created metadata object is persisted for future execution.

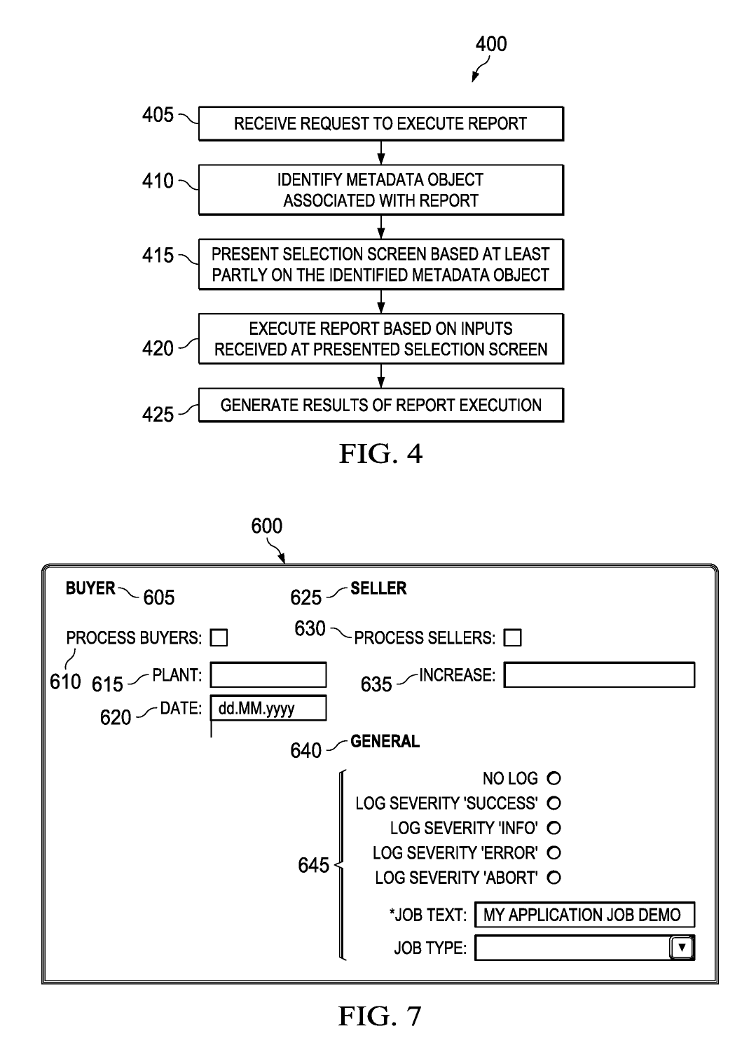

FIG. 4 is an illustration of example operations for executing a report in the enhanced user experience environment based on the additional metadata layer and existing report functionality. For clarity of presentation, the description that follows generally describes method 400 in the context of the system 100 illustrated in FIG. 1. However, it will be understood that method 400 may be performed, for example, by any other suitable system, environment, software, and hardware, or a combination of systems, environments, software, and hardware as appropriate.

At 405, a request to execute a particular report is received. In some instances, the request can be received via a UX application or system, such as UX system 160. At 410, the previously created metadata object associated with the requested report is identified. In some instances, a gateway service may perform the operations associated with identifying the corresponding metadata object based on the association to the requested report. Further, the gateway service may combine or join the existing and newly created metadata for the UX application to use in generating the enhanced selection screen.

At 415, an enhanced selection screen is presented based at least partly on the enhancements included in the metadata object as applied to the existing metadata of the existing report. The enhanced selection screen is rendered by the UX application and allows users to provide inputs for the one or more identified parameters.

At 420, in response to receiving inputs at the presented selection screen, the inputs are passed to the coding associated with the existing report where the inputs are used to perform the operations associated with report. At 425, the results of the report execution are generated. In some instances, this may include presentation of a result screen, completion or addition to a particular log or event database, or performance of one or more additional operations.

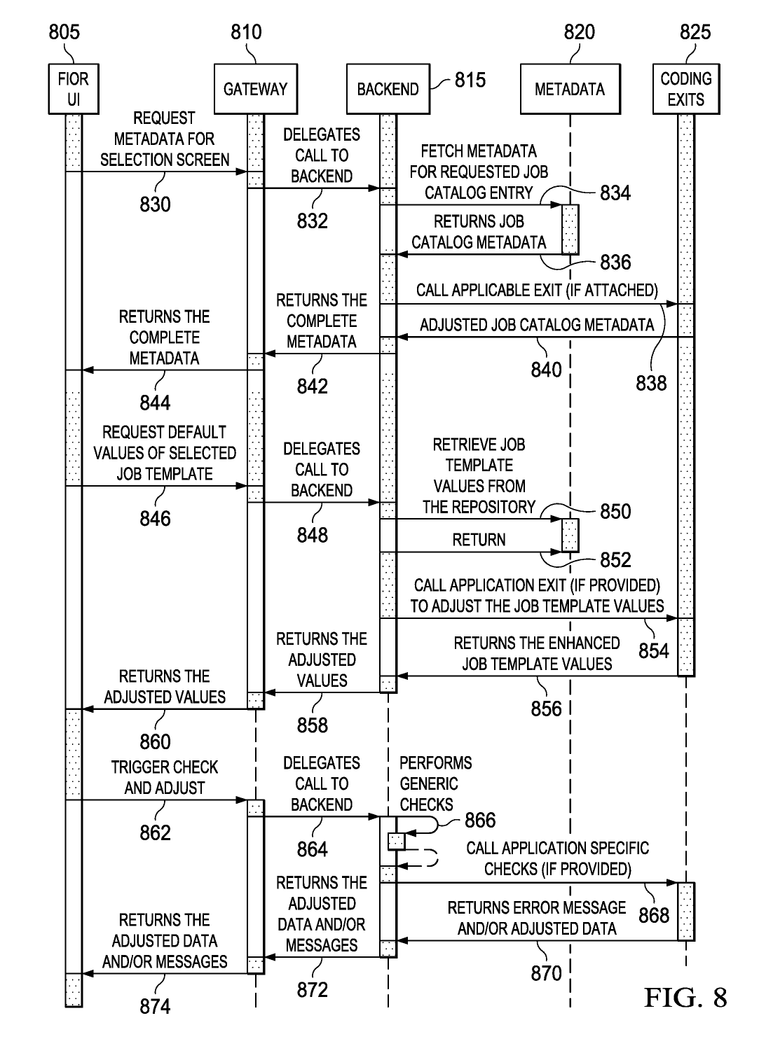

FIG. 8 is an illustration of an example swim lane diagram 800 associated with operations for executing a report in the enhanced user experience environment. For clarity of presentation, the description that follows generally describes diagram 800 in the context of the system 100 illustrated in FIG. 1. However, it will be understood that the operations of diagram 800 may be performed, for example, by any other suitable system, environment, software, and hardware, or a combination of systems, environments, software, and hardware as appropriate.

As illustrated, an enhanced UX application—here, FIORI UI 805—is used to call a previously enhanced selection screen and report based on a set of enhanced metadata stored in a metadata repository 820. FIORI UI 805 requests the enhanced selection screen via gateway 810, which delegates calls to backend system 815. In some instances, one or more application exits may exist, such that additional operations associated with particular applications may be performed, where the application, or coding exits 825 are accessed by the backend system 815.

At 830, the FIORI UI 805 receives or determines a particular application and selection screen to be rendered. The FIORI UI 805 sends a request for the metadata corresponding to the enhanced selection screen to the gateway 810. The gateway 810 converts the request and delegates the call to the backend system 815 at 832.

At 834, in response to the received request, the backend system 815 fetches the existing set of metadata and any enhanced metadata associated with the selection screen from the metadata repository 820. This can include obtaining the original set of metadata plus accessing and retrieving the enhanced metadata from the corresponding metadata object, both of which may be located at the metadata repository 820. In some instances, the existing set of metadata and the metadata object may be stored at different locations, as well as in different repositories. The two sets of metadata may be linked, for instance, by a header, unique identifier, or any other suitable connection such that the backend system 815 is able to access both sets of metadata. At 836, the combined set of metadata is returned to the backend system 815 in response to its fetch operations.

In some instances, one or more coding exits 825 may exist that change the operation of the selection screen and the underlying application. The coding exits 825 may modify the operation of the selection screen, may alter parameters or values associated with the retrieved metadata, or may perform one or more dependency checks or other validations, among other actions. At 838, and prior to returning the retrieved metadata from the metadata repository 820, the backend system 815 can call to the coding exits 825 to determine if any particular application exits or modifications are to be performed. In some instances, the metadata itself may identify the particular application exits to be included or associated with a particular instance of the selection screen, such that the metadata itself triggers the call to the coding exits 825 when reviewed by the backend system 815. If the metadata is changed in response to the coding exits 825, the adjusted metadata is returned to the backend system 815 at 840.

At 842, the backend system 815 returns the complete set of metadata to the gateway 810, where the gateway 810 can then prepare and return the metadata to the FIORI UI 805 at 844. While not shown here, the FIORI UI 805 can then render the selection screen based on the previously enhanced metadata to provide the enhanced presentation as described herein.

At 846, the FIORI UI 805 requests a set of default values associated with a particular entry in the selection screen, the request sent to the backend system 815 via gateway 810, which relays the request, including an translation or transformation, at 848. The backend system 815 retrieves, at 850, the corresponding default values from the metadata repository 820, which returns the appropriate values at 852. Prior to returning the values to the FIORI UI 805 via the gateway 810, the backend system 815 may determine whether one or more application exits should be called to adjust the default values. If necessary, at 854, the application exits associated with the particular metadata and/or users accessing the selection screens are called from the coding exits 825 such that the default values are modified. For example, default values may be time or user-dependent, or the default values may be a specific value. Example default values may include the current date, the last seven days, or the organizational unit of the current user. Alternative values can be used to adjust those default values, or to make those values the default, as appropriate. At 856, those modified values are returned to the backend system 815, where the value changes are made. At 858, the backend system 815 returns the default values (and any adjustments or modifications to those values) to the gateway 810, which returns the adjusted values to the FIORI UI 805 at 860.

At 862, actions performed at the selection screen within the FIORI UI may cause additional checks and adjustments to be calculated in the values provided within the selection screen. For example, an explicit UI trigger may cause information to be updated, checked, revised, or otherwise processed. In other instances, user actions may cause specific triggers to occur, including completing a field in the selection screen, changing focus within the fields, or any other suitable action as defined by a rule set or the operations of the selection screen. The check triggered by the actions can include a verification of the data, data types, particular dependencies, and other checks associated with the data. The gateway 810 receives the triggered request to check the data and delegates a call to the backend system 815 to perform the checks. At 866, the backend system 815 performs the checks associated with the selection screen. If necessitated by the backend system 815, the metadata associated with the selection screen, or another reason, the backend system 815 can call application specific checks as needed at 868, the coding exits 825 returning errors messages or adjusted data as necessary at 870. At 872, and in response to the checking of the inputs and any application-specific checks, the backend system 815 returns the adjusted data and/or any error or status messages provided during the checks to gateway 810, which then returns that information to the FIORI UI 805 at 874.

Described implementations of the subject matter can include one or more features, alone or in combination.

For example, in a first implementation, a computer-implemented method includes identifying an existing report for migration to an enhanced user experience application, the existing report associated with a set of existing metadata for selection screen presentation of the existing report and backend coding for execution of the existing report; creating a metadata object associated with the identified report; replicating at least some of the existing metadata associated with the identified existing report into the created metadata object; receiving at least one enhancement to the created metadata object, the at least one enhancement including at least one additional metadata attribute to be represented in an updated selection screen presentation associated with the enhanced user experience application; and persisting the created metadata object for later execution.

The foregoing and other described implementations can each optionally include one or more of the following features:

A first feature, combinable with any of the following features, further comprising receiving a request to execute the identified report in the enhanced user experience application; identifying the created metadata object associated with the particular report; present the updated selection screen based at least partly on the identified metadata object, the updated selection screen presentation including the at least one enhancement of the created metadata object applied to the existing metadata associated with the existing report; and executing the identified report based on input received via the updated selection screen, wherein executing the identified report comprises using the backend coding for execution.

A second feature, combinable with any of the previous or following features, wherein the backend coding for execution comprises the backend coding associated with the existing report.

A third feature, combinable with any of the previous or following features, wherein the metadata object is associated with the identified report based on a header corresponding to the name of the identified report.

A fourth feature, combinable with any of the previous or following features, wherein the operations are performed by a generic service operable to migrate any existing report to the enhanced user experience application.

A fifth feature, combinable with any of the previous or following features, wherein replicating at least some of the existing metadata associated with the identified existing report into the created metadata object comprises identifying a set of parameters associated with the existing report; and incorporating at least a portion of the identified set of parameters into the created metadata object.

A sixth feature, combinable with any of the previous or following features, wherein the at least one additional metadata attribute includes layout information associated with the updated selection screen presentation, a determination of one or more mandatory fields within the updated selection screen presentation, a grouping of fields within the updated selection screen presentation, and dependency information between at least two fields in the updated selection screen presentation.

A seventh feature, combinable with any of the previous or following features, wherein the at least one additional metadata attribute includes a set of coding value help information, the coding value help information identifying a range or type of value information associated with at least one field included in the updated selection screen presentation.

An eighth feature, combinable with any of the previous or following features, wherein the existing report is associated with a legacy system.

A ninth feature, combinable with any of the previous or following features, wherein the created metadata object is persisted in the same location as the existing report.

In a second implementation, a computer program product comprising computer-readable instructions, which, when loaded and executed on a computer system, cause the computer system to perform operations comprising: identifying an existing report for migration to an enhanced user experience application, the existing report associated with a set of existing metadata for selection screen presentation of the existing report and backend coding for execution of the existing report; creating a metadata object associated with the identified report; replicating at least some of the existing metadata associated with the identified existing report into the created metadata object; receiving at least one enhancement to the created metadata object, the at least one enhancement including at least one additional metadata attribute to be represented in an updated selection screen presentation associated with the enhanced user experience application; and persisting the created metadata object for later execution.

The foregoing and other described implementations can each optionally include one or more of the following features:

A first feature, combinable with any of the following features, further comprising receiving a request to execute the identified report in the enhanced user experience application; identifying the created metadata object associated with the particular report; present the updated selection screen based at least partly on the identified metadata object, the updated selection screen presentation including the at least one enhancement of the created metadata object applied to the existing metadata associated with the existing report; and executing the identified report based on input received via the updated selection screen, wherein executing the identified report comprises using the backend coding for execution.

A second feature, combinable with any of the previous or following features, wherein the backend coding for execution comprises the backend coding associated with the existing report.

A third feature, combinable with any of the previous or following features, wherein the metadata object is associated with the identified report based on a header corresponding to the name of the identified report.

A fourth feature, combinable with any of the previous or following features, wherein the operations are performed by a generic service operable to migrate any existing report to the enhanced user experience application.

A fifth feature, combinable with any of the previous or following features, wherein replicating at least some of the existing metadata associated with the identified existing report into the created metadata object comprises identifying a set of parameters associated with the existing report; and incorporating at least a portion of the identified set of parameters into the created metadata object.

A sixth feature, combinable with any of the previous or following features, wherein the at least one additional metadata attribute includes layout information associated with the updated selection screen presentation, a determination of one or more mandatory fields within the updated selection screen presentation, a grouping of fields within the updated selection screen presentation, and dependency information between at least two fields in the updated selection screen presentation.

A seventh feature, combinable with any of the previous or following features, wherein the at least one additional metadata attribute includes a set of coding value help information, the coding value help information identifying a range or type of value information associated with at least one field included in the updated selection screen presentation.

An eighth feature, combinable with any of the previous or following features, wherein the existing report is associated with a legacy system.

A ninth feature, combinable with any of the previous or following features, wherein the created metadata object is persisted in the same location as the existing report.

In some implementations, the computer program product can be implemented on a non-transitory, computer-readable medium storing one or more instructions executable by a computer system to perform the above-described operations.

In a third implementation, a computer system, comprising: a computer memory; and a hardware processor interoperably coupled with the computer memory and configured to perform operations comprising: identifying an existing report for migration to an enhanced user experience application, the existing report associated with a set of existing metadata for selection screen presentation of the existing report and backend coding for execution of the existing report; creating a metadata object associated with the identified report; replicating at least some of the existing metadata associated with the identified existing report into the created metadata object; receiving at least one enhancement to the created metadata object, the at least one enhancement including at least one additional metadata attribute to be represented in an updated selection screen presentation associated with the enhanced user experience application; and persisting the created metadata object for later execution.

The foregoing and other described implementations can each optionally include one or more of the following features:

A first feature, combinable with any of the following features, further comprising receiving a request to execute the identified report in the enhanced user experience application; identifying the created metadata object associated with the particular report; present the updated selection screen based at least partly on the identified metadata object, the updated selection screen presentation including the at least one enhancement of the created metadata object applied to the existing metadata associated with the existing report; and executing the identified report based on input received via the updated selection screen, wherein executing the identified report comprises using the backend coding for execution.

A second feature, combinable with any of the previous or following features, wherein the backend coding for execution comprises the backend coding associated with the existing report.

A third feature, combinable with any of the previous or following features, wherein the metadata object is associated with the identified report based on a header corresponding to the name of the identified report.

A fourth feature, combinable with any of the previous or following features, wherein the operations are performed by a generic service operable to migrate any existing report to the enhanced user experience application.

A fifth feature, combinable with any of the previous or following features, wherein replicating at least some of the existing metadata associated with the identified existing report into the created metadata object comprises identifying a set of parameters associated with the existing report; and incorporating at least a portion of the identified set of parameters into the created metadata object.

A sixth feature, combinable with any of the previous or following features, wherein the at least one additional metadata attribute includes layout information associated with the updated selection screen presentation, a determination of one or more mandatory fields within the updated selection screen presentation, a grouping of fields within the updated selection screen presentation, and dependency information between at least two fields in the updated selection screen presentation.

A seventh feature, combinable with any of the previous or following features, wherein the at least one additional metadata attribute includes a set of coding value help information, the coding value help information identifying a range or type of value information associated with at least one field included in the updated selection screen presentation.

An eighth feature, combinable with any of the previous or following features, wherein the existing report is associated with a legacy system.

A ninth feature, combinable with any of the previous or following features, wherein the created metadata object is persisted in the same location as the existing report.

The preceding figures and accompanying description illustrate example processes and computer implementable techniques. But environment 100 (or its software or other components) contemplates using, implementing, or executing any suitable technique for performing these and other tasks. It will be understood that these processes are for illustration purposes only and that the described or similar techniques may be performed at any appropriate time, including concurrently, individually, or in combination. In addition, many of the steps in these processes may take place simultaneously, concurrently, and/or in different orders than as shown. Moreover, environment 100 may use processes with additional steps, fewer steps, and/or different steps, so long as the methods remain appropriate.

In other words, although this disclosure has been described in terms of certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure.

What is claimed is:

1. A computerized method for migrating reports to an enhanced user experience using an enhanced metadata repository, the method executed by a processer and comprising:
identifying an existing report for migration to an enhanced user experience application via creation of an enhanced report, the existing report associated with a set of existing metadata for selection screen presentation of the existing report and backend coding for execution of the existing report, the set of existing metadata stored in a unified metadata repository;
creating a metadata object associated with the identified report;
replicating at least some of the existing metadata associated with the identified existing report into the created metadata object based on the relationship between the existing report and the enhanced report;
incorporating at least one enhancement to the existing metadata into the created metadata object, the at least one enhancement including at least one additional metadata attribute to be represented in an updated selection screen presentation associated with the enhanced user experience application; and
persisting the created metadata object for later execution of the enhanced report in the unified metadata repository.

2. The method of claim 1, further comprising:
receiving a request to execute the identified report in the enhanced user experience application;
determining the created metadata object associated with the particular report;
present the updated selection screen based at least partly on the identified metadata object, the updated selection screen presentation including the at least one enhancement of the created metadata object applied to the existing metadata associated with the existing report; and
executing the identified report based on input received via the updated selection screen, wherein executing the identified report comprises using the backend coding for execution.

3. The method of claim 2, wherein the backend coding for execution comprises the backend coding associated with the existing report.

4. The method of claim 1, where the metadata object is associated with the identified report based on a header corresponding to the name of the identified report.

5. The method of claim 1, wherein the operations are performed by a generic service operable to migrate any existing report to the enhanced user experience application.

6. The method of claim 1, wherein replicating at least some of the existing metadata associated with the identified existing report into the created metadata object comprises:
identifying a set of parameters associated with the existing report; and
incorporating at least a portion of the identified set of parameters into the created metadata object.

7. The method of claim 1, wherein the at least one additional metadata attribute includes layout information associated with the updated selection screen presentation, a determination of one or more mandatory fields within the updated selection screen presentation, a grouping of fields within the updated selection screen presentation, and dependency information between at least two fields in the updated selection screen presentation.

8. The method of claim 1, wherein the at least one additional metadata attribute includes a set of coding value help information, the coding value help information identifying a range or type of value information associated with at least one field included in the updated selection screen presentation.

9. The method of claim 1, wherein the existing report is associated with a legacy system.

10. The method of claim 1, wherein the created metadata object is persisted in the same location as the existing report.

11. A computer system, comprising:
a computer memory; and
a hardware processor interoperably coupled with the computer memory and configured to perform operations comprising:
identifying an existing report for migration to an enhanced user experience application via creation of an enhanced report, the existing report associated with a set of existing metadata for selection screen presentation of the existing report and backend coding for execution of the existing report, the set of existing metadata stored in a unified metadata repository;
creating a metadata object associated with the identified report;
replicating at least some of the existing metadata associated with the identified existing report into the created metadata object based on the relationship between the existing report and the enhanced report;
incorporating at least one enhancement to the existing metadata into the created metadata object, the at least one enhancement including at least one additional metadata attribute to be represented in an updated selection screen presentation associated with the enhanced user experience application; and
persisting the created metadata object for later execution, the created metadata object persisted in the unified metadata repository.

12. The system of claim 11, the operations further comprising:
receiving a request to execute the identified report in the enhanced user experience application;
identifying the created metadata object associated with the particular report;
presenting the updated selection screen based at least partly on the identified metadata object, the updated selection screen presentation including the at least one enhancement of the created metadata object applied to the existing metadata associated with the existing report; and
executing the identified report based on input received via the updated selection screen, wherein executing the identified report comprises using the backend coding for execution.

13. The system of claim 12, wherein the backend coding for execution comprises the backend coding associated with the existing report.

14. The system of claim 11, where the metadata object is associated with the identified report based on a header corresponding to the name of the identified report.

15. The system of claim 11, wherein the operations are performed by a generic service operable to migrate any existing report to the enhanced user experience application.

16. The system of claim 11, wherein replicating at least some of the existing metadata associated with the identified existing report into the created metadata object comprises:
identifying a set of parameters associated with the existing report; and
incorporating at least a portion of the identified set of parameters into the created metadata object.

17. The system of claim 1, wherein the at least one additional metadata attribute includes layout information associated with the updated selection screen presentation, a determination of one or more mandatory fields within the updated selection screen presentation, a grouping of fields within the updated selection screen presentation, and dependency information between at least two fields in the updated selection screen presentation.

18. The system of claim 11, wherein the existing report is associated with a legacy system.

19. The system of claim 11, wherein the created metadata object is persisted in the same location as the existing report.

20. A non-transitory, computer-readable medium storing computer-readable instructions executable by a computer to:
identify an existing report for migration to an enhanced user experience application via creation of an enhanced report, the existing report associated with a set of existing metadata for selection screen presentation of the existing report and backend coding for execution of the existing report;
create a metadata object associated with the identified report;
replicate at least some of the existing metadata associated with the identified existing report into the created metadata object based on the relationship between the existing report and the enhanced report;
incorporating at least one enhancement to the existing metadata into the created metadata object, the at least one enhancement including at least one additional metadata attribute to be represented in an updated selection screen presentation associated with the enhanced user experience application; and
persist the created metadata object for later execution.
